(19) United States
(12) Patent Application Publication
(10) Pub. No.: US 2015/0228033 A1
(43) Pub. Date: Aug. 13, 2015

(54) PORTRAYING AN INDIVIDUAL THROUGH USE OF ARTIFACTS FOR SOCIAL NETWORKING AND PLAYING

(71) Applicants: Frederic Zenhausern, Fountain Hills, AZ (US); Ryan Stephen Zenhausern, Fountain Hills, AZ (US); Alissia Marguerite Zenhausern, Fountain Hills, AZ (US); Nicole Michele Zenhausern, Fountain Hills, AZ (US)

(72) Inventors: Frederic Zenhausern, Fountain Hills, AZ (US); Ryan Stephen Zenhausern, Fountain Hills, AZ (US); Alissia Marguerite Zenhausern, Fountain Hills, AZ (US); Nicole Michele Zenhausern, Fountain Hills, AZ (US)

(21) Appl. No.: 14/153,063

(22) Filed: Feb. 12, 2014

(51) Int. Cl. G06Q 50/00; G06Q 30/00

(52) U.S. Cl. CPC G06Q 50/01; G06Q 30/00

(57) ABSTRACT

A method and apparatus platform for portraying a first individual relating to engaging in social activities, such as networking and/or playing, with at least a second individual, through using artifacts, preferably an image and/or an art work, that can be displayed at a physical or virtual exhibit, whose elements of said artwork can be extracted or described by the individuals for identifying or defining some personal and/or psychological attributes that can translate, pattern or portrait unique characters of the individuals, for example with the purpose of interacting, communicating, playing, gaming, entertaining, initiating courtship or intimate relationship, networking or trading.

### FIELD OF THE INVENTION

Embodiments described herein pertain generally to a system and method for providing an interactive communication platform using artifacts with the overall goal of engaging individuals into personal acts that can convey portraying physical, emotional, or virtually expressing desire for performing some mutual social activities related to playing, courtship, intimate relationship, sharing, procuring, commerce, partnering and/or trading real or digital information.

### BACKGROUND

According to certain embodiments of the disclosed subject matter, a search for prior art was performed whose outcome didn't identify any report(s) pertinent to the innovation depicted in the present invention. For clarity, the references incorporated therein are only illustrative of a broad landscape of some aspects of the information depicted in the background section, but all reference departing in nature from the present invention. These references list as the following: U.S. 2012/0275643A1 to Beckford et al., Nov. 1, 2012 entitled: “Purchasing photographic products from a software application on a mobile electronic device application”; U.S. 2012/02966677A1 to Julka et al., Nov. 22, 2012 entitled: “Systems and methods for online sale of artwork”; U.S. Pat. No. 8,398,081B1 to Girolmo et al., Mar. 19, 2013 entitled: “Combination dice and board game and associated method”; U.S. Pat. No. 8,529,351B2 to Kane, Sep. 10, 2013 entitled: “Systems and method for playing a role playing”; and U.S. 2013/0190019A1 to Granito et al., entitled: “Personalized location information for mobile devices”.

Current social networking services, such as systems employed for online communication (e.g. Facebook, Instagram, WhatsApp), typically utilize information selected and provided by an individual (e.g. pictures, text or other document, weblinks) for the purpose of sharing said information during a session using a digital network or the internet, and within the individual's core of contact users, often listed in a database of authorized users, for example comprised of family members, friends, collaborators, professional colleagues, lovers or business partners and so on. The information is often created, selected, filtered or controlled by the individual posting it for a pre-determined purpose of projecting a personal profile with special features controlled by said individual. There are no perspective or assessment of said profile displayed by first individual to be critically reviewed by said a second individual who may want to emphasize a special aspect or attributes of his/her review of the described attributes through his/her interaction(s) that may convolute or embed modulated or modified attributes in view of carrying multiple features, in part or in full modification of the attributes for the purpose of engaging into a multiple bodies interaction, for example from the family of dialog, communication, trade or relationship.

Often communication between individuals is mediated by various attitudes reflecting positive and negative traits of human personality. So the dimensions of personality can have multiple expressions of thoughts, emotions, relationship and interaction. Obviously, the actions or reactions can be influenced by situations and environmental or contextual conditions. The present invention is not intended to define new models but it leverages various models borrowed from modern psychology and other scientific knowledge known to those skilled in the prior art.

Today, many contemporary personality psychologists believe that there are five basic dimensions of personality, often referred to as the “Big 5” personality traits. Previous trait theorist had suggested a various number of possible traits, including Gordon Allport's list of 4,000 personality traits, Raymond Cattell's 16 personality factors and Hans Eysenck's three-factor theory. However, many researchers felt that Cattell's theory was too complex and Eysenck's was too limited in scope. Today, many researchers believe that they are five core personality traits. Evidence of this theory has been growing over the past 50 years, beginning with the research of D. W. Fiske (1949) and later expanded upon by other researchers including Norman (1967), Smith (1967), Goldberg (1981), and McCrae & Costa (1987). The “big five” are broad categories of personality traits. While there is a significant body of literature supporting this five-factor model of personality, researchers don't always agree on the exact labels for each dimension. However, these five categories are usually described as follows: (1) Extraversion: This trait includes characteristics such as excitability, sociability, talkativeness, assertiveness and high amounts of emotional expressiveness; (2) Agreeableness: This personality dimension includes attributes such as trust, altruism, kindness, affection, and other pro-social behaviors; (3) Conscientiousness: Common features of this dimension include high levels of thoughtfulness, with good impulse control and goal-directed behaviors. Those high in conscientiousness tend to be organized and mindful of details; (4) Neuroticism: Individuals high in this trait tend to experience emotional instability, anxiety, moodiness, irritability, and sadness and (5) Openness: This trait features characteristics such as imagination and insight, and those high in this trait also tend to have a broad range of interests.

It is important to note that each of the five personality factors represents a range between two extremes. For example, extraversion represents a continuum between extreme extraversion and extreme introversion. In the real world, most people lie somewhere in between the two polar ends of each dimension. McCrae and his colleagues have also found that the big five traits are also remarkably universal. One study that looked at people from more than 50 different cultures found that the five dimensions could be accurately used to describe personality. Based on this research, many psychologists now believe that the five personality dimensions are not only universal; they also have biological origins. Psychology David Buss has proposed that an evolutionary explanation for these five core personality traits, suggesting that these personality traits represent the most important qualities that shape the human social landscape. Always remember that behavior involves an interaction between a person's underlying personality and situational variables. The situation that a person finds himself or herself in plays a major role in how the person reacts. However, in most cases, people offer responses that are consistent with their underlying personality traits.

These dimensions represent broad areas of personality. Research has demonstrated that these groupings of characteristics tend to occur together in many people. For example, individuals who are sociable tend to be talkative. However, these traits do not always occur together. Personality is a complex and varied and each person may display behaviors across several of these dimensions. Personal traits are also components that can be exploited in the activity of gaming or entertaining and multiple forms have been often used in role playing.

Numerous models of gamer psychology have been proposed and debated over the past couple of decades. One of the earliest and simplest has proven to be one of the most referenced and most enduring: the Bartle Types. This model is a functional model of human personality in a game playing context. In other words, the Bartle typology works because it's a subset of a more general personality model that works. In fact, several of the best-known play style and game design models share many conceptual elements. So it has also been proposed that the Bartle typology, the play style models of Caillois, Lazzaro, and Bateman, and the game design models of Edwards and Hunicke/LeBlanc/Zubek are all variations on a single Unified Model of play styles. Some of the embodiments of the present invention include accessing objects such as artwork as component(s) of its gaming application as it is described below.

World's largest museums display only a fraction of their collections which comprise million of objects kept behind the public scenes. Although recent efforts have emerged enabling online viewing and/or even recreation of some of the objects on 3D-printers, there is no report how to leverage these objects for new forms of social communication. However, there have been multiple demonstrations of healing using art and music therapies as well as communication of emotional connection of artists through their artwork. Some non-profit institutions have developed initiatives supporting cancer or psychiatric patients through art exhibits or public events. For example, the annual “Oncology on Canvas™” competition invite people who have been touched by cancer—patients, family members, friends, caregivers, and healthcare providers—to express through art and narrative, the life-affirming changes that give their cancer journeys meaning. Then, the artwork created by these people are selected for publication and touring exhibits at hospitals and cancer centers through the United States. The present invention allows integration of emotional components for developing personal patterns for portraying individuals engaged into social activities.

There is also a significant trend in globalizing art market with the development of technology start-ups specializing in online art sales and/or exhibits. For example, companies such as Artsy, Artspace, Paddle8 have been backed by investors. Large auction houses (e.g. Christie's, Sotheby) also began developing online catalogs and a variety of galleries and museums have since joined online sites. There is a site organized around the Art Genome Project, collaboration between art historians and computer scientists who map connections between works of art. For example, US patent application 20120296677 A1 to Julka et al., and entitled: “Systems and methods for online sale of artwork” describes a system and method of transacting purchases of artwork using communications networks between collector clients.

There are no prior art related to the present invention provided a random object in an online social network platform, whose description of its intrinsic physical features are translated into information content, either abstract or concrete, that can be communicated between individual users for the purpose of establishing a form of personal communication, trading, coding or exchange of knowledge and/or information.

### SUMMARY

Accordingly, the embodiments presented herein can provide methods and systems for identifying, designing, processing, manufacturing communicating and distributing a portrait information for establishing some cognitive pattern information between some individuals preferably engaged in some social networking activity in view of dialoging and/or communicating possibly abstract, concrete or mixed thereof information, for the purpose of engaging into social behaviors and/or interactions from the categories of commerce, courtship, communicating, trading, exchanging or any other physical or intellectual activity human individuals may recognize or respond to.

In one approach, the embodiment can include a method and system for entertaining, playing or gaming either in a configuration using accessories commonly used in board games for example, in role playing, but also in other gaming activity using scoring systems, positioning features and descriptors in a standard step of social playing.

In one approach, the method and system for portraying comprises virtual configurations using mobile electronic appliances and digital networks, electronic databases and other digital resources for performing the present invention in a virtual environment. Other features will become more apparent to persons having ordinary skill in the art to which the method and apparatus pertain and from the following description and claims.

### BRIEF DESCRIPTION OF THE DRAWINGS

FIG. 1 illustrates the concept of the present invention using artifacts descriptors for engaging into a dialog between at least two individuals for the purpose of establishing communication, courtship, trading or other interactive interaction.

FIG. 2 illustrates an electronic embodiment of the invention exploiting electronic components that are typically used in a digital transaction using a network and preferably the internet or the like.

FIG. 3 illustrates a general overview of a system used with social networking platform that doesn't interface with artifacts, and emphasis of some of the other components claimed in the present invention.

FIG. 4 illustrates an embodiment of the present invention when relating to its implementation into an electronic system compatible with interfacing with social networking and internet based systems.

FIG. 5 illustrates a variation of FIG. 4 when a multitude of users are involved in the proposed system and method of the invention

FIG. 6 illustrates an embodiment of the present invention when related to playing game using artifacts preferably available from a list of art works from an exhibit in a art institution (e.g. gallery or museum).

FIG. 7. illustrates an electronic embodiment of FIG. 6 suitable for using broad types of artifacts (e.g. scientific instrumentation objects)

FIG. 8. illustrates an embodiment using virtual and digital components such as personal electronic appliances, in particular smart phones, and social networks available on the internet using state-of-the-art network infrastructure for connecting to some exhibits and artifacts whose display can be visualize by users for extracting features in view of communication.

### DETAILED DESCRIPTION

The following description is not to be taken in a limiting sense, but it is made merely for the purpose of describing the general principles of exemplary embodiments. The scope of the invention should be determined with reference to the claims.

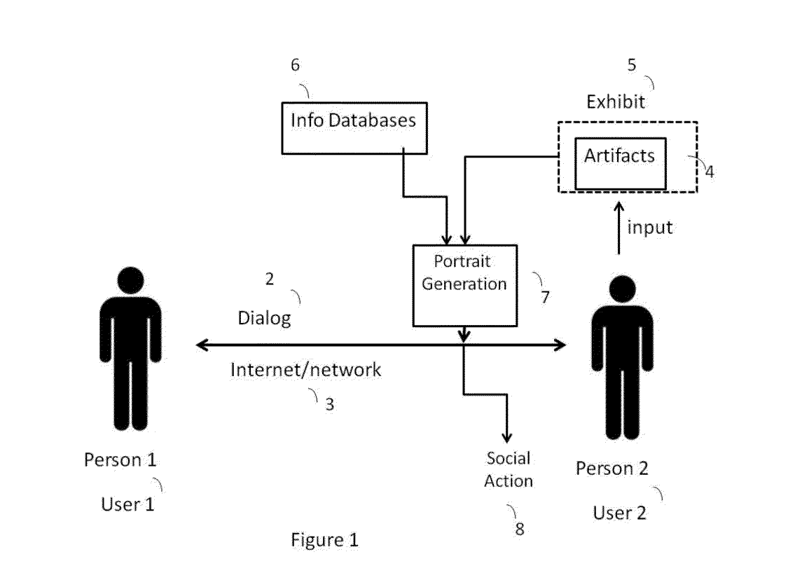

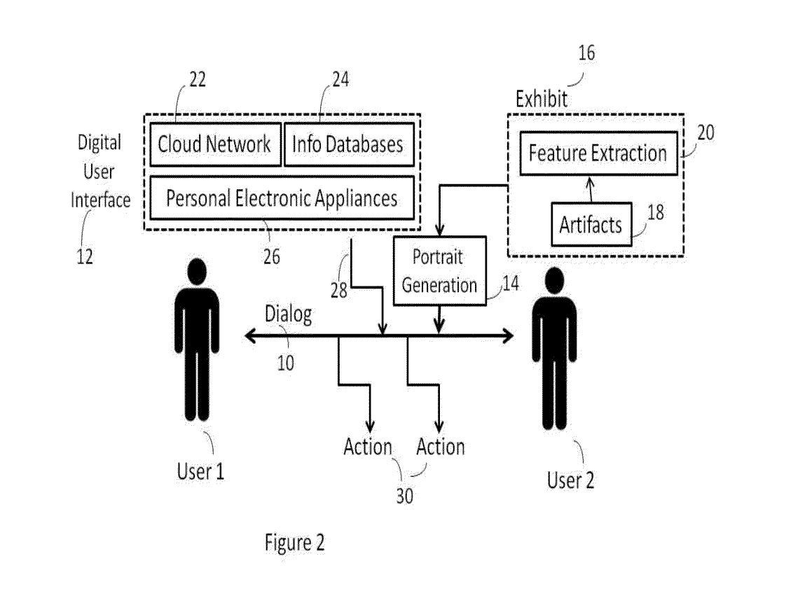

FIG. 1 illustrates the concept of the present invention emphasizing an embodiment for which two users -1&2- or individuals engage into a dialog -2- through a conventional social networking system -3- (e.g. internet or other network, for example the one used in Facebook™) but wherein a user, for example user 2, will access an online site where an object or artifact -4-, for example an artwork at a museum, can be displayed as part of an exhibit -5- or any other display made available to the public. The user 2 will also access information databases -6- preferably related to the selected artifact or other complementary sources of information allowing user 2 to describe some personal characters or traits of user 1 using abstract features from the artifact (e.g. color, shape, structure or texture) for generating a portrait -7- of user 1, for example, in view of establishing a personal dialog enabling intangible attributes, for example from the family of emotions, cognition, or other category of attributes that can characterize a personality for generating a portrait of user 1 in view of developing social action -8- such as courtship, trading, communicating, exchanging of information or knowledge or any other action that can be perceived by most of human senses (i.e. vision, touch, smell, audition). FIG. 2 depicts an embodiment highlighting more specific components of FIG. 1, in particular user 1 and user 2 establishing a dialog -10- by enabling a digital user interface -12- and a portrait generator -4. The portrait generator -14- is preferably comprised of components such as an exhibit -16- which relates to at least one artifact -18- selected by user 2 who will perform feature extraction -20- to input the portrait generator -14-. Similarly, the digital user interface -12- will be using a combination of components such as a cloud network -22-, at least one information database -24- both suitable for some connection with at least one personal electronic appliance -26-, preferably from the family of computing devices such as a computer, a smart phone, a tablet computer, a laptop for generating some input signals -28- that will be modulating said dialog -10- for generating action(s) -30- suitable for setting emotional response between both users, for example in view of dating, trading or any other interactive social behavior(s).

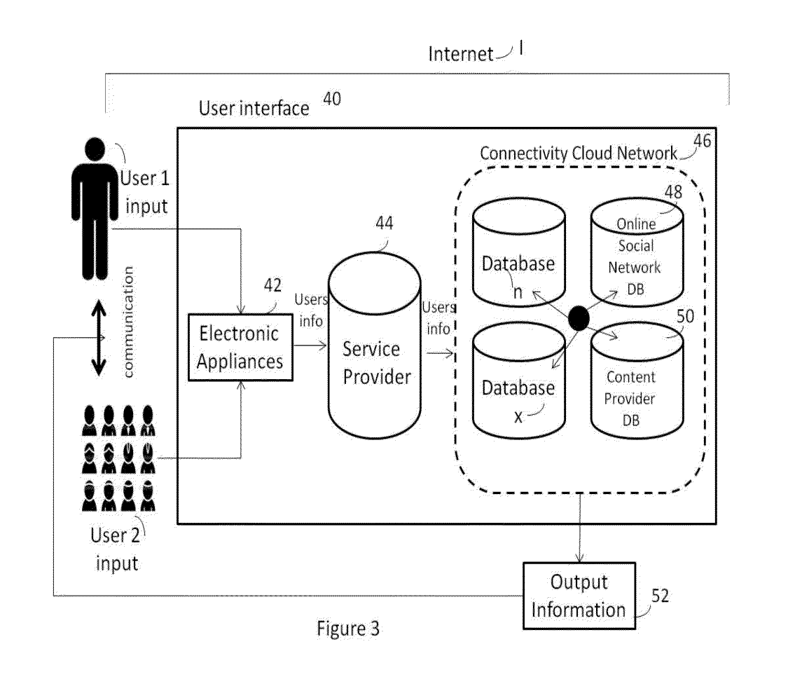

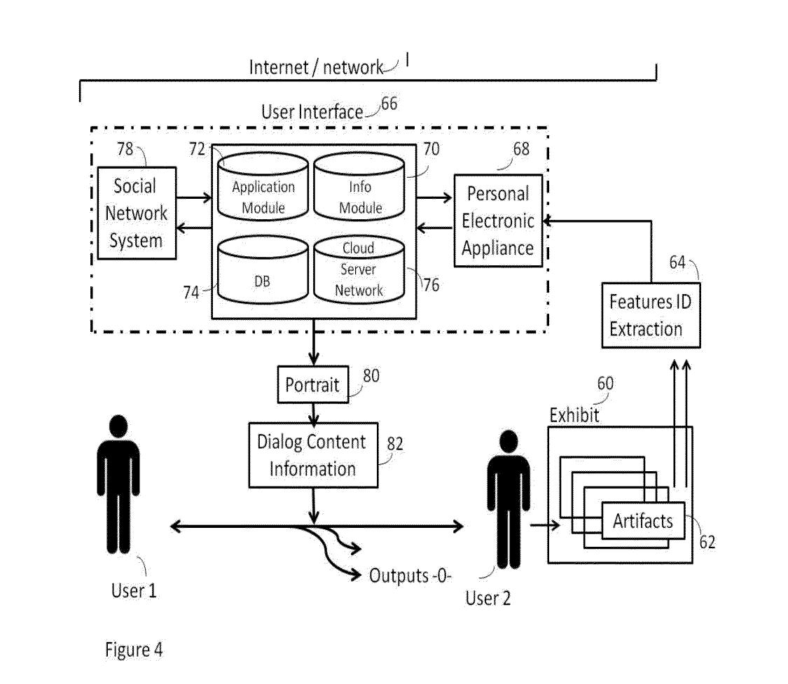

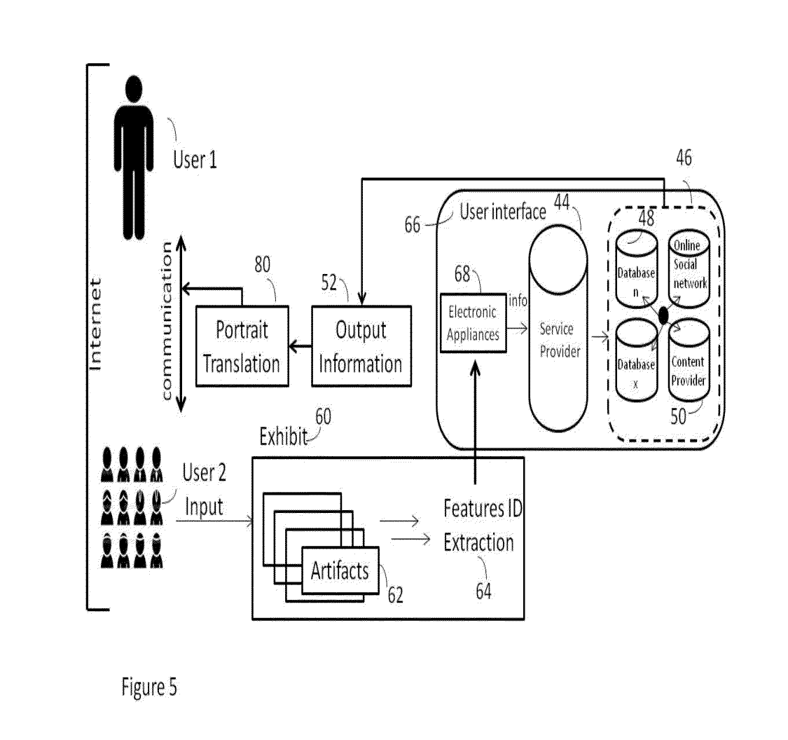

The embodiment of FIG. 3 refers to the prior art of conventional social networking. Typically, user 1 enter communication over the internet -I- with at least user 2 or a group of second users through a user interface -40- comprising multiple components such as accessing of electronic appliances -42- that can exchange digital information about the users using information and communications capabilities from at least a service provider -44- that allow interrogating said information through connection with a cloud network -46- that often comprise modules such as databases (n,x), other specialized modules for online social networking -48-, content provider database -50- or other type of infrastructure architecture known by those skilled in the prior art. The output information -52- is generated from the above system for supplying content information of the communication between the users. FIG. 4 illustrates some of the novel embodiments of the present invention. In particular, this configuration sets up user 1 and user 2 for establishing communication by entering a processing pathway comprising the user 2 accessing an exhibit -60- that can be a virtual or physical display of artifacts -62- that can be interrogated, analyzed, manipulated or created by the user 2 in view of extracting some features -64- which may have characteristics representative of an identification of traits, characters or identification of user 1 perceived by user 2 who can be processed by an algorithm for generating information suitable for linking with a user interface -66- composed of a personal electronic appliance -68- connected through a series of modules such as information modules -70-, application modules -72-, databases -74-, cloud server network -76- and coupling with a social network system -78- to produce multiple parameters and/or patterns suitable for establishing a portrait -80- to enable some dialog information content -82- whose multi-dimensionality allow users to provide a response mixing conscious, existent, tangible components with abstract, emotional, unconscious and intangible components that will modulate outputs -84- for a fulfilling human experience suitable for complex social behaviors beyond the conventional direct exchange of factual information. This multi-dimensional experience can trigger behavior(s) related to engaging in personal activities such as dating, trading, exchanging, entertain or any other social activity that can be mediated by emotional, unconscious or intangible information of part thereof. FIG. 5 highlights a variation of arrangement of modules of the embodiment presented in FIGS. 3 and 4, when multiple users are involved in performing the method of the proposed invention.

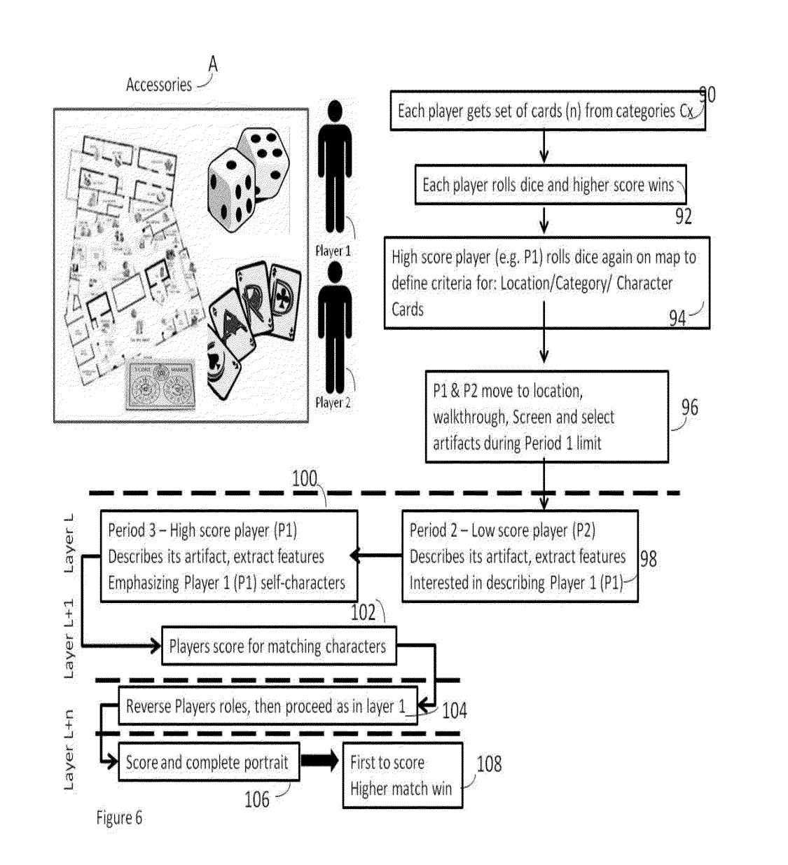

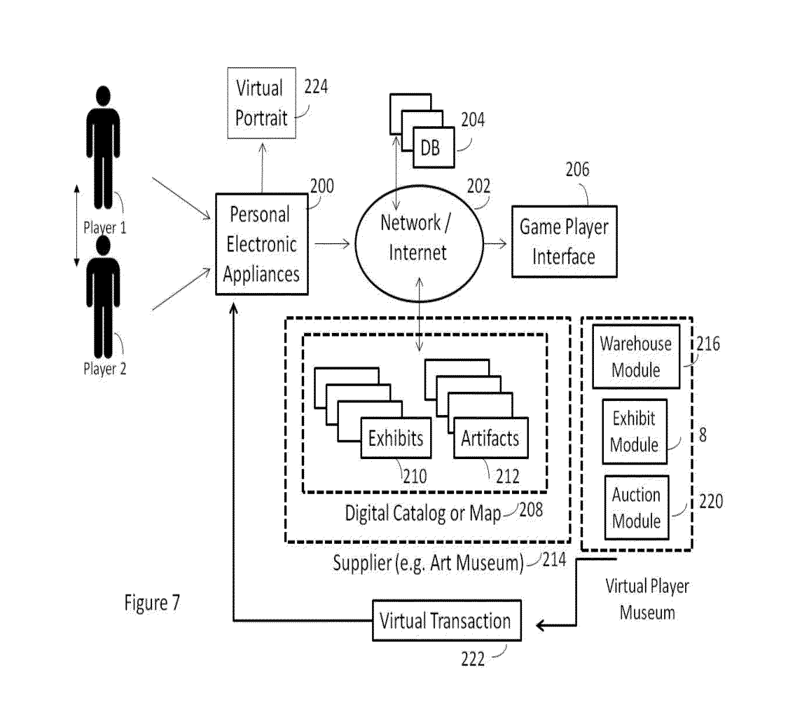

The attention is now directed to FIGS. 6 and 7 describing specific configurations of the present invention for the application of gaming, either by implementing a physical platform displayed in FIG. 6, for example a form of a board game, or its virtual platform in FIG. 7, for example using a electronic appliances such as tablet computer, smart phones or other electronic device preferably using a touch screen and/or voice activation/recognition module(s). In the embodiment of FIG. 6, the present invention can be performed by a set of players 1&2 using some accessories -A- that are conventional components of board games, for example dice, cards, maps, score markers or other component that can provide an element of chance to add some adventure and luck to the game. During a setup phase -90- of the game, each player will receive randomly distributed sets of cards (n) from a card deck comprising several categories (Cx) describing (i) various locations related to the map(s) provided in the set of accessories -A-, (ii) physical attributes such as colors, texture (e.g. smooth, rough, flexible, warm, cold) shapes, dimensions, (iii) descriptive behavioral characters (e.g. aggressive, discreet, arrogant) or emotional traits (e.g. happy, sad, loving, affectionate) or (iv) any other conscious or unconscious features that could be captured in abstract or real icon to be useful in a board game. The object is to select a sequence of actions for initiating the game so each player will roll the dice and the player with the higher score, or designated as the lead player, will be assigned the first priority for playing as indicated by step -92-. Then, in step -94-, the lead player will roll the dice that will define (1) a random location on the map, for example a specific space such as an exhibit room located on a museum map (e.g. 3^{rd} floor Modern Art Paintings Exhibit) or any specific space where the dice will stop on the detailed map selected for the game. The lead player will also roll 2 dices whose scores will multiply to determine a period of time Pt₁ to be spent at the selected location or exhibit, while the second player will roll the dices similarly to determine a period of time Pt₂ that will limit the amount of time used to process the following step. Then, all players will move physically to the exhibit space where in step -96- they will walkthrough, explore, screen and select each a piece of artwork or artifact (AW), whose selection should best represent feature patterns that could be used to best “portrait” the personality of the player(s) without revealing or sharing their respective choice during the allocated period of time Pt₁. Then, in step -98- during period Pt₂, the second or “non-lead” player will present his/her description to the first or “lead” player of his/her selected artwork sharing tangible and intangible features portraying said first player from a personal conscious and/or unconscious perspective in view of communicating some physical, emotional, social or any other factual interaction between the players. In step -100- and using a similar period Pt₂, the first or lead player will proceed similarly describing his/her selected artwork but self-portraying his/her own perspective of his/her personality. Each player will also try to exploit as many characters or attributes for their description using his/her set of cards. In step -102- the players will compare how many cards Cx fit some traits of the respective portraits and the player with the largest number of cards used will win the higher score through a mechanism for calculating points (e.g. using a card scoring system with different weighting factor for different categories). This will constitutes a first layer of the game, so then the roles of the players are switched and a next cycle of the game -104- can be played with inversed players and so on forming multiple layers L+n until one of the player will score with the higher number of points representative of the highest match of a complete portrait -106- and no more card for a win of the game -108-.

An illustration of the above embodiment is a scenario comprising a human couple, for example, whose female partner will describe some artistic features extracted from a modern art painting to express her feelings, for example directed to the male partner through the description of colors, shapes or other component of the artwork that can support sharing information in view of portraying, one or both, individual(s) and/or their social behavior or interactions for engaging in activities such as courtship, communicating, meeting, sporting or any interactive activity and so on.

FIG. 7 is a digital embodiment that could support the implementation of the previous embodiment to be integrated into a virtual environment suitable for interfacing with internet architecture and social networks. In this embodiment, the players 1&2 interact using personal electronic appliances -200- (e.g. tablet computer, smart phones, computing device) that can access the internet and other state-of-the-art digital network infrastructure -202- preferably linked to databases -204- and other user interface modules including some game player interface -206- providing connectivity with other sources of virtual information such as digital catalogs, maps -208- or other forms of electronic content of exhibit -210- and artifacts -212- that can be visualized by the public from virtual sites of suppliers/providers of artwork (e.g. gallery, museum, warehouse, studios) -214- whose infrastructure may also include multiple digital components such as a warehouse module -216- an exhibit module -218- or an auction module -220- suitable for providing the players with a virtual museum environment to proceed with virtual transaction -222- compatible with their personal electronic appliances for performing gaming activities similar to the ones depicted in FIG. 6 but in a virtual configuration of portrait -224- that can contribute to the dialog or communication between the players for facilitating their engagement into social behaviors or activities such as courtship, communicating, trading or other form of conscious or unconscious interaction(s). Note that said virtual environment could have 2D, 3D or multi-dimensions as well as the objects or artifacts for practicing the present invention.

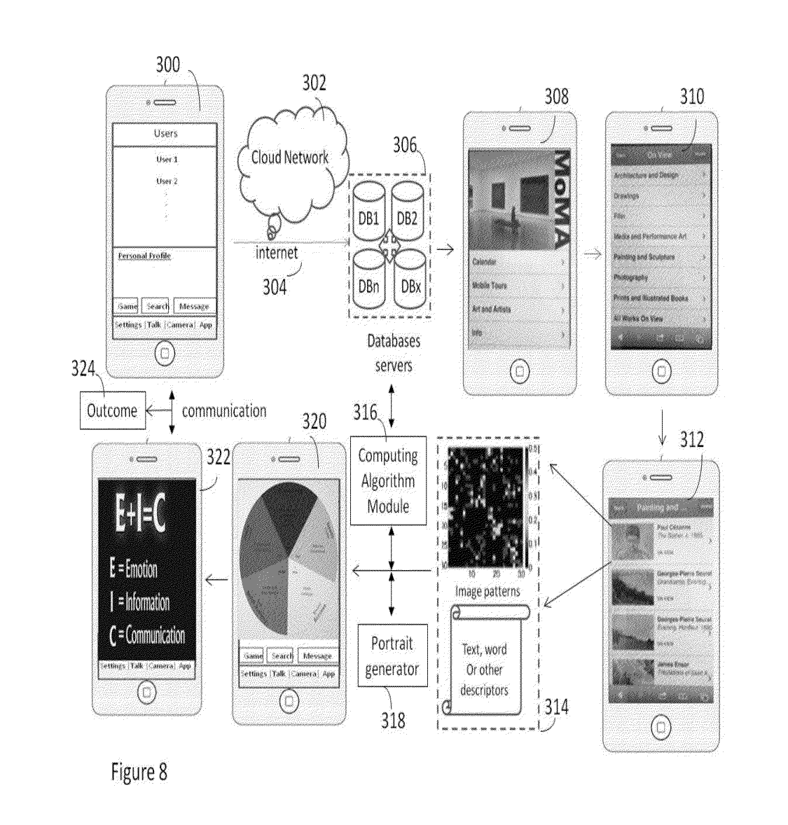

Now, attention is directed towards the embodiment depicted in FIG. 8 which emphasizes some of the main components that can enable the present invention into a virtual implementation using readily available electronic devices, digital networks and information analysis resources for preferably performing in a mobile environment. In FIG. 8, a number n of users/players (e.g. n=2) will use a mobile smart phone or tablet device -300- accessible through an appropriate communication infrastructure for exchanging information and personal profile typically defined in most common forms or platforms of social networks. Preferably the devices will be link to a cloud network -302- internee network -304- and several databases and servers -306- providing information, for example, at a website from an institution, in particular but not exclusively an art museum -308- where the users can access and visualize different layers of information related to different categories of artworks -310-, artists and media and for example a virtual painting -312- whose physical or visual components can be extracted and/or translated into patterns of abstract or concrete information the user(s) can then manipulate, modify or combine using multiple types of descriptors exploiting text characters, words, image components to define some contextual vehicle -314- that can either be introduced to a computing algorithm module -316- or be directly depicted by generating a portrait -318- that can highlight subjective attributes that can be translated into a map -320- describing emotions, senses or other cognitive features the user(s) are interested to compile or converge into a portrait information -322- that can be communicated between users in view of engaging into some outcome -324 or social behavior or activities such as dating, trading, dialoging, sporting or any other physical and intellectual activity human may apply for developing social interactions. It is also of relevance to notice artwork can comprise objects such as drawings, art crafts, paintings, sculpture or any other form of physical or virtual expression media that can be also generated by said individuals that can also be shared or communicated using part or in full the infrastructure components described above in the present invention. In the above embodiments, the invention can also be configured using several modules from the category of user interface (e.g. GUI device), processing module (e.g. CPUs from an electronic chip or chipsets compatible with GSM, CDMA, and/or combination of electronic components including memory devices as DRAM, MRAM), computation module (e.g. laptop computer, duster computer) and conversion modules (e.g. software platforms with algorithms suitable for pattern recognition processing using mathematical models from statistical, image, texture analysis or the like).

One of ordinary skill in the art will appreciate that starting components, devices, algorithm, network architecture, infrastructure, resources, social networks, databases, data analysis methods, cognitive features or attributes, patterns or portraits, accessories, and information processing and/or communication methods other than those specifically exemplified can be employed in the practice of the invention without resort to undue experimentation. AH art-known functional equivalents, of any such systems and methods are intended to be included in this invention. The terms, idioms and diagrams which have been employed are used as terms of description and not of limitation, and there is no intention that in the use of such terms, idioms and diagrams of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method for developing a relationship between individuals using a social communication network and databases of information relating to objects, such as artifacts, and possibly referring to a specific location, the method being performed preferably by using a processing unit for describing and translating some of the features of said one or more artifact into components that can be representative of personal characters in view of portraying at least one of the individuals for engaging into interactive forms of communication, exchange or trade, the method comprising:
Establishing a connection request between at least a first individual through a social network system for interrogating at least a second individual;
Specifying at least one location of information resources for accessing at least one object, preferably from the category of artifact such as an image or artwork;
Arranging for the individuals to access some user interface features inviting individuals accessing a location wherein views of artifact(s) can be provided to said individuals;
Determining at least a mutual field of interest within said location and type(s) of artifact(s) providing scope for defining some parameters for describing specific features of said artifact(s);
Comparing at least one of the processing of said parameters by the individuals referencing to at least one descriptive component relating to a personality model or psychological, physical, emotional, intimate, sensual or the like characters relative to social behaviors or activities that can be preferably portraying the individuals;
And
Translating the combination of portraits information into content that can be processed in multiple levels of interactive relationship between said individuals who may experience complementary forms of communication qualities, exchange of information, or other form(s) of social interaction, relationship between said individuals

2. A method according to claim 1 comprising digital social network such as the commonly product platforms readily available to the public, for example commercial products and services supplied by Facebook, Tweeter, or the like.

3. A method according to claim 1, wherein said artifact can be created and produced by nature or by at least one of said individuals, for example from the category of drawings, paintings, art crafts, sculpture, fabrics, ceramics or any other media that can reproduce multi-dimensional object(s).

4. A method accordingly to claim 1, wherein the database of information are from the category of listing and displaying artwork collections from a museum, art gallery or other public database or private information made available for sharing with the individuals.

5. A method according to claim 3 whose database of information includes reference to a location of said database or of its content such as a database of a museum or institution that may have the capacity of displaying a digital image of an artifact or its physical feature.

6. A method according to claim 1 comprising a processing unit preferably from the group of computing devices, portable electronic appliances, for example a smart phone, tablet or laptop computer, but also from any electronic system that can be linked to a network for the purpose of exchanging information.

7. A method according to claim 1 whose artifact can be preferably from the family of painting, pictures, sculptures, objects or any other form of art that can be exhibited in a manner that can be detected by the human senses, i.e. vision, audition, touch or smell, or by a cognitive stimulus or response that can be translated into said content information.

8. A method according to claim 1 wherein individuals can connect within an internet site where they are eligible for communicating and sharing access to other digital sites for sharing databases of information, for example a map for locating some artifacts.

9. A method according to claim 1 wherein artifacts can be detected by the individuals for exchanging description of some attributes defined by said individuals.

10. A method according to claim 1 wherein component comprises tangible physical attributes of a body or an object, for example dimensions, color, structure, shape but also some intangible attributes relating to the translation of a perception from at least one of the individuals in view of combining some pattern information into a portrait.

11. A method according to claim 1 wherein translating portraits information can result in interactive engagement between the individuals for the purpose of communicating, courtship or other intimate relationship, trading or any other form of social interacting.

12. An apparatus for processing a digital pattern profiling a relationship between individuals, the apparatus comprising a system for accessing a social communication network and databases of information relating to artifacts, and possibly comprising a navigation system for positioning a location, the apparatus operating preferably with a processing algorithm for describing and translating some of the features of said one or more artifact into digital components that can be representative of personal characters in view of portraying at least one of the individuals for engaging into interactive forms of digital communication, exchange or trade, the system of the apparatus comprising:
A connecting module for establishing a digital connection request between at least a first individual and user of a social network system for interrogating at least a second individual or user;
A first processing module that can process a first algorithm for specifying at least one location of information resources for accessing at least one artifact, preferably from the category of images or artwork listed in an electronic inventory or displayed into a digital exhibit, preferably made available for visualization on an internet network system
A user interface module for facilitating the individuals to access some user interface features inviting individuals accessing at least a specific location wherein views of artifacts can be provided to said individuals;
A second processing module using a second algorithm for determining at least a mutual field of interest within said location and type(s) of artifact(s) providing scope for defining some parameters for describing specific features of said artifact(s);
A computation module for performing comparative calculation of at least one of the processing of said parameters by the individuals referencing to at least one descriptive component relating to a personality model or psychological, physical, emotional, intimate, sensual or the like characters relative to social behaviors or activities that can generate a pattern preferably portraying of the individuals;
And
A conversion module for translating the combination of portraits information into digital content that can be processed by some digital network(s) into multiple levels of interactive patterns of relationship(s) between said individuals whose patterns may be representative of complementary forms of communication qualities, exchange of information, or other form(s) of social interaction, relationship between said individuals

13. An apparatus according to claim 12, whom connecting module is preferably a connectivity device such as a cable modem, LAN, satellite internet connection device or other type of network, for example, internet connection device.

14. An apparatus according to claim 12, wherein said processing module is a computer and said electronic inventory can be a spreadsheet from a database or any equivalent digital file that can be suitable for a user of the internet or other network.

15. An apparatus according to claim 12, the second processing module can generate description of features from the category of color, shape, structure, or any other physical properties that can be described through a visual examination of said artifact.

16. A method according to claim 1 wherein commercial products are from corporate entities and/or institutions practicing business using electronic transaction(s) or commerce, for example internet based companies.

17. A method according to claim 16 wherein said companies are from the group of Facebook, Twitter, Pinterest, WhatsApp, Google Plus, Tumblr, Stumble Upon, but also from Artspace, Artsy, Paddle8 or eBay, Craigslist, Google, Yahoo, eBay or equivalent internet based company.

18. An apparatus accordingly to claim 12, whose activities can comprise commerce, courtship, trading, communicating, auctioning, selling, blogging, advertising, recruiting or any other activity of exchange of information that can be performed preferably through a network, preferably, the internet.

19. An apparatus according to claim 12 wherein location comprise a virtual or physical facility from the category of institution(s) such as a bank, a warehouse, a retail store, a museum, or from a building structure, such as a wall, a bridge, a tower, a pole, a billboard or a natural component of a landscape, such as a boulder, a tree or other site that can be used for displaying an object accessible to the view of the public.

20. An apparatus according to claim 12 whose conversion module can comprise a computing system using software algorithm(s) suitable for image analysis, for example using a data processor programmed with instructions for providing either unsupervised or supervised pattern recognition algorithm, or other mathematical algorithms from the family of clustering, filtering, texturing analysis or any other mathematical techniques for interrogating information from patterns.
